(19) United States
(12) Patent Application Publication
(10) Pub. No.: US 2012/0206374 A1
(43) Pub. Date: Aug. 16, 2012

(54) SYSTEMS AND METHODS FOR SCREEN DATA MANAGEMENT

(75) Inventors: Ying-Ju CHEN, Taoyuan County (TW); Hsueh-Chun CHEN, Taoyuan County (TW); Nicole Alexandra CODDINGTON, Taoyuan County (TW)

(73) Assignee: HTC CORPORATION, Taoyuan City (TW)

(21) Appl. No.: 13/026,610

(22) Filed: Feb. 14, 2011

(51) Int. Cl. G06F 3/041

(52) U.S. Cl. 345/173

(57) ABSTRACT

Methods and systems for screen data management are provided. First, a screenshot is generated for screen data displayed in a touch-sensitive display unit. Contacts and movements of an object on the touch-sensitive display unit are received. It is determined whether the object is a pen or not. When the object is a pen, gestures corresponding to the contacts and movements of the object are recorded. Then, an event is received. In response to the event, the screenshot and the gestures corresponding to the contacts and movements of the object are merged to generate an integrated screenshot.

### BACKGROUND OF THE INVENTION

1. Field of the Invention

The disclosure relates generally to methods and systems for screen data management, and, more particularly to methods and systems that automatically generate a screenshot for screen data and gestures of an object on the touch-sensitive display unit.

2. Description of the Related Art

Recently, portable devices, such as handheld devices, have become more and more technically advanced and multifunctional. For example, a handheld device may have telecommunications capabilities, e-mail message capabilities, an advanced address book management system, a media playback system, and various other functions. Due to increased convenience and functions of the devices, these devices have become necessities of life.

Currently, a handheld device may be equipped with a touch-sensitive display unit. Users can directly perform operations, such as application operations and data input via the touch-sensitive display unit. Generally, in computer systems, users can press a print screen key to generate a screenshot of screen data currently displayed in the display unit. However, no screenshot function is provided in the handheld devices.

Additionally, in some case, users may browse data, such as web pages or e-books using the handheld devices, and make some notes on the data via the touch-sensitive display unit of the handheld devices. Since the data to be browsed and the notes belong to independent applications, the data and the notes are respectively stored, and no association therebetween is provided. When users want to review the data, it is complicated for users to re-build the association between the data and the corresponding notes, and it is also impossible to share data integrated with the corresponding notes with others.

### BRIEF SUMMARY OF THE INVENTION

Methods and systems for screen data management are provided.

In an embodiment of a method for screen data management, a screenshot is generated for screen data displayed in a touch-sensitive display unit. Contacts and movements of an object on the touch-sensitive display unit are received. It is determined whether the object is a pen or not. When the object is a pen, gestures corresponding to the contacts and movements of the object are recorded. Then, an event is received. In response to the event, the screenshot and the gestures corresponding to the contacts and movements of the object are merged to generate an integrated screenshot

An embodiment of a system for screen data management includes a storage unit, a touch-sensitive display unit, and a processing unit. The touch-sensitive display unit displays screen data. The processing unit generates a screenshot for the screen data displayed in the touch-sensitive display unit. The processing unit receives contacts and movements of an object on the touch-sensitive display unit. The processing unit determines whether the object is a pen or not, and records gestures corresponding to the contacts and movements of the object to the storage unit when the object is a pen. The processing unit receives an event, and in response to the event, merges the screenshot and the gestures corresponding to the contacts and movements of the object to generate an integrated screenshot.

In an embodiment of a method for screen data management, screen data is displayed in a touch-sensitive display unit. Contacts and movements of an object on the touch-sensitive display unit are received. It is determined whether the object is a pen or not. When the object is a pen, gestures corresponding to the contacts and movements of the object are displayed in the touch-sensitive display unit. Then, a screenshot for the screen data and the gestures corresponding to the object on the touch-sensitive display unit is generated.

In some embodiments, an operation is further performed to the screen data displayed in the touch-sensitive display unit based on the gestures corresponding to the contacts and movements of the object when the object is not a pen.

In some embodiments, the screenshot for the screen data displayed in the touch-sensitive display unit is generated periodically, or when the object touches the touch-sensitive display unit.

In some embodiments, the event comprises a save instruction, or a share instruction, and the integrated screenshot can be saved to the storage unit or transmitted to a device via a wireless network.

Methods for screen data management may take the form of a program code embodied in a tangible media. When the program code is loaded into and executed by a machine, the machine becomes an apparatus for practicing the disclosed method.

### BRIEF DESCRIPTION OF THE DRAWINGS

The invention will become more fully understood by referring to the following detailed description with reference to the accompanying drawings, wherein:

FIG. 1 is a schematic diagram illustrating an embodiment of a system for screen data management of the invention;

FIG. 2 is a flowchart of an embodiment of a method for screen data management of the invention;

FIG. 3 is a schematic diagram illustrating an embodiment of an example of screen data management of the invention; and

FIG. 4 is a flowchart of another embodiment of a method for screen data management of the invention.

### DETAILED DESCRIPTION OF THE INVENTION

Methods and systems for screen data management are provided.

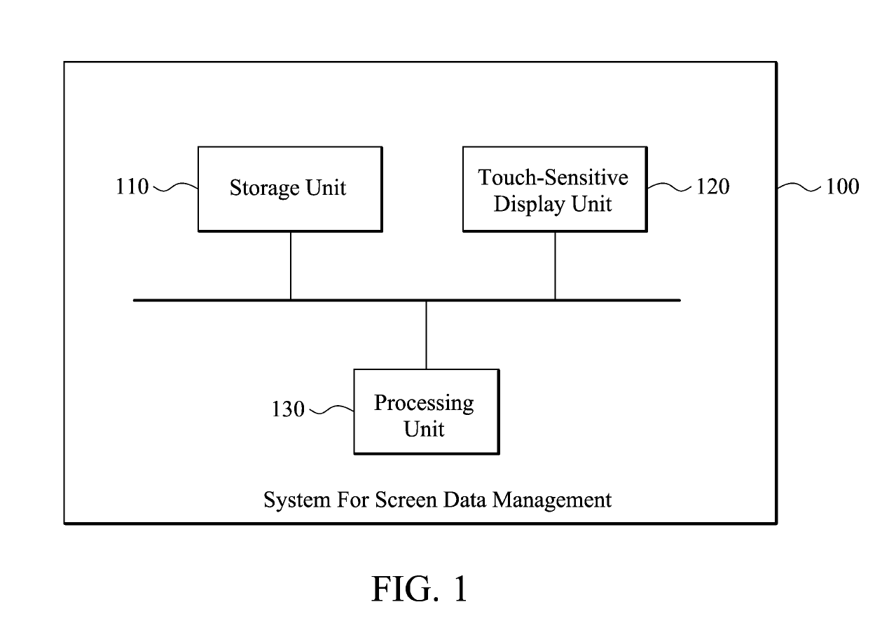

FIG. 1 is a schematic diagram illustrating an embodiment of a system for screen data management of the invention. The system for screen data management can be used in an electronic device, such as a PDA (Personal Digital Assistant), a smart phone, a mobile phone, an MID (Mobile Internet Device, MID), a laptop computer, a car computer, a digital camera, a multi-media player, a game device, or any other type of mobile computational device, however, it is to be understood that the invention is not limited thereto.

The system for screen data management 100 comprises a storage unit 110, a touch-sensitive display unit 120, and a processing unit 130. The storage unit 110 can be used to store related data, such as calendars, files, web pages, images, and/or interfaces. The touch-sensitive display unit 120 is a screen integrated with a touch-sensitive device (not shown). The touch-sensitive device has a touch-sensitive surface comprising sensors in at least one dimension to detect contact and movement of an object (input tool), such as a pen/stylus or finger near or on the touch-sensitive surface. The touch-sensitive display unit 120 can display the data provided by the storage unit 110. It is understood that, in some embodiments, the data displayed in the touch-sensitive display unit 120 can be updated. For example, when users use the electronic device to visit a web site via a wireless network communication (not shown), related web pages displayed in the touch-sensitive display unit 120 may be dynamically updated. The processing unit 130 can perform the method for screen data management of the present invention, which will be discussed further in the following paragraphs. It is noted that, the processing unit 130 can further determine whether an object on the touch-sensitive display unit 120 is a pen or not. In some embodiment, the processing unit 120 determines whether the object is a pen or not by detecting whether a pen is in proximity to the electronic device or the touch-sensitive display unit. It is understood that, in some embodiments, a pen may have at least one physical button. When the physical button on the pen is pressed, a signal is transmitted from the pen to a reception unit (not shown) of the system. When the signal transmitted from the pen is detected/received, a pen is determined as in proximity to the electronic device or the touch-sensitive display unit.

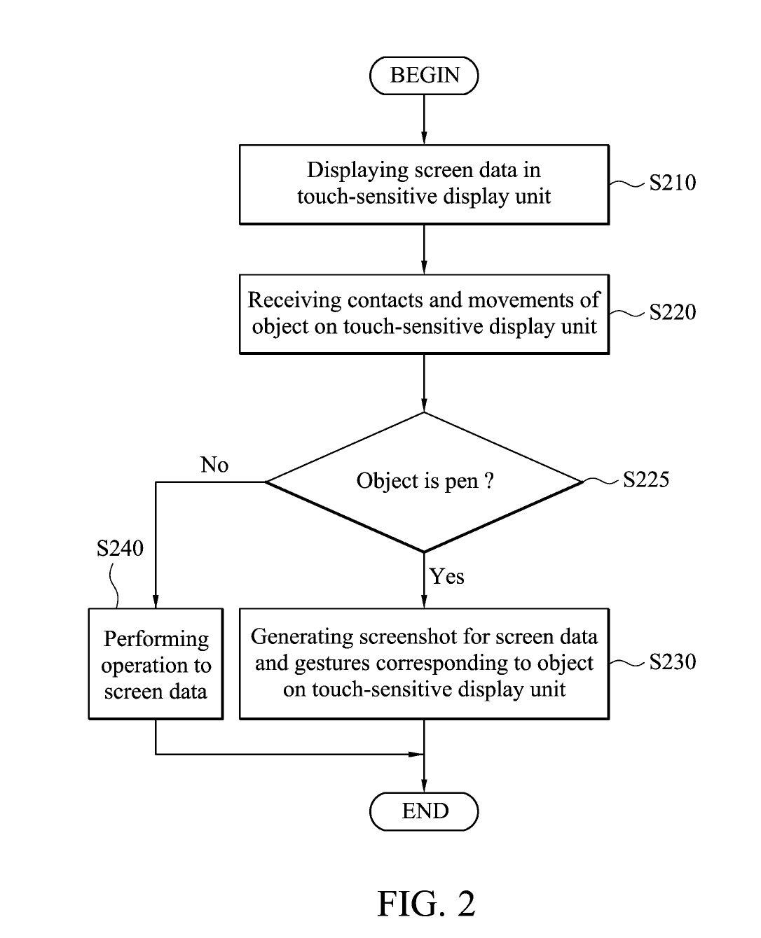

FIG. 2 is a flowchart of an embodiment of a method for screen data management of the invention. The method for screen data management can be used for an electronic device, such as a PDA, a smart phone, a mobile phone, an MID, a laptop computer, a car computer, a digital camera, a multi-media player or a game device.

In step S210, screen data is displayed in the touch-sensitive display unit 120. It is understood that, in some embodiments, the screen data can be obtained from the storage unit 110. In some embodiments, the screen data can be downloaded from a web site, and the screen data may be dynamically updated. In step S220, contacts and movements of an object, such as a pen/stylus or a finger near or on the touch-sensitive display unit 120 are received/detected. It is understood that, in some embodiments, users may use the object to make notes or perform operations to the screen data. In step S225, it is determined whether the object is a pen or not. It is understood that, in some embodiments, it is determined whether the object is a pen or not by detecting whether a pen is in proximity to the electronic device or the touch-sensitive display unit. In some embodiments, when a signal transmitted from the pen is detected/received, a pen is determined as in proximity to the electronic device or the touch-sensitive display unit. When the object is a pen (Yes in step S225), in step S230, a screenshot for the screen data and gestures corresponding to the object on the touch-sensitive display unit is generated. It is understood that, in some embodiments, the screen data and the gestures can be merged to generate the screenshot. Further, it is understood that, in some embodiments, the screen data can be obtained from a memory buffer (not shown) of the touch-sensitive display unit 120, or directly from an application, such as a browser. It is noted that, when the object is a pen, the contacts and movements of the object on the touch-sensitive display unit 120 can form gestures, and the gestures corresponding to the object can be displayed in the touch-sensitive display unit 120. It is understood that, in some embodiments, a multi-layer display technique can be employed in the present application, wherein multiple display layers can be displayed simultaneously in the touch-sensitive display unit 120. When multiple display layers are simultaneously displayed in the touch-sensitive display unit 120, all or a part of a picture displayed in a lower display layer can be covered by another picture displayed in an upper display layer. The upper display layer is visually above the lower display layer. In some embodiments, the gestures corresponding to the object can be displayed in the upper display layer, and the screen data can be displayed in the lower display layer. When the object is not a pen (No in step S225), in step S240, an operation is performed to the screen data based on the gestures corresponding to the object on the touch-sensitive display unit. For example, when the object is a pen, the gesture corresponding to the object is displayed in the upper display layer, and used to generate a screenshot with the screen data. When the object is not a pen, for example a finger, an operation is performed to the screen data displayed in the lower display layer based on the gesture corresponding to the object. That is, the gesture corresponding to the object is applied to the screen data displayed in the lower display layer when the object is not a pen. For example, when a user uses a pen to draw a line on the touch-sensitive display unit, the line will be displayed in the touch-sensitive display unit, as a note to the screen data displayed in the touch-sensitive display unit. When a user uses a finger to draw a line on the touch-sensitive display unit, the line will be a command to pan the screen data displayed in the touch-sensitive display unit.

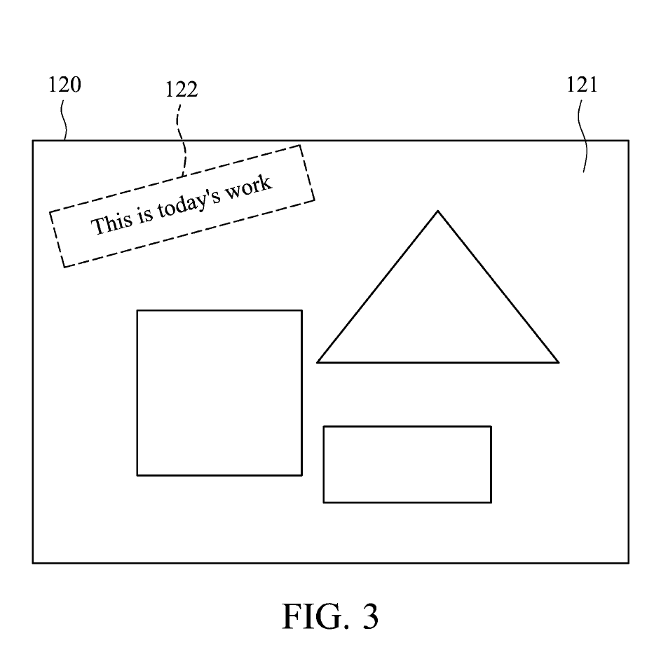

FIG. 3 is a schematic diagram illustrating an embodiment of an example of screen data management of the invention. As shown in FIG. 3, the touch-sensitive display unit 120 can display screen data 121. Users can use a pen to make notes 122 on the touch-sensitive display unit 120. The screen data 121 and the notes 122 can be simultaneously displayed in the touch-sensitive display unit 120. The system for screen data management 100 of the present application can automatically generate a screenshot by integrating the screen data 121 and the notes 122. The screenshot can be saved or shared to others.

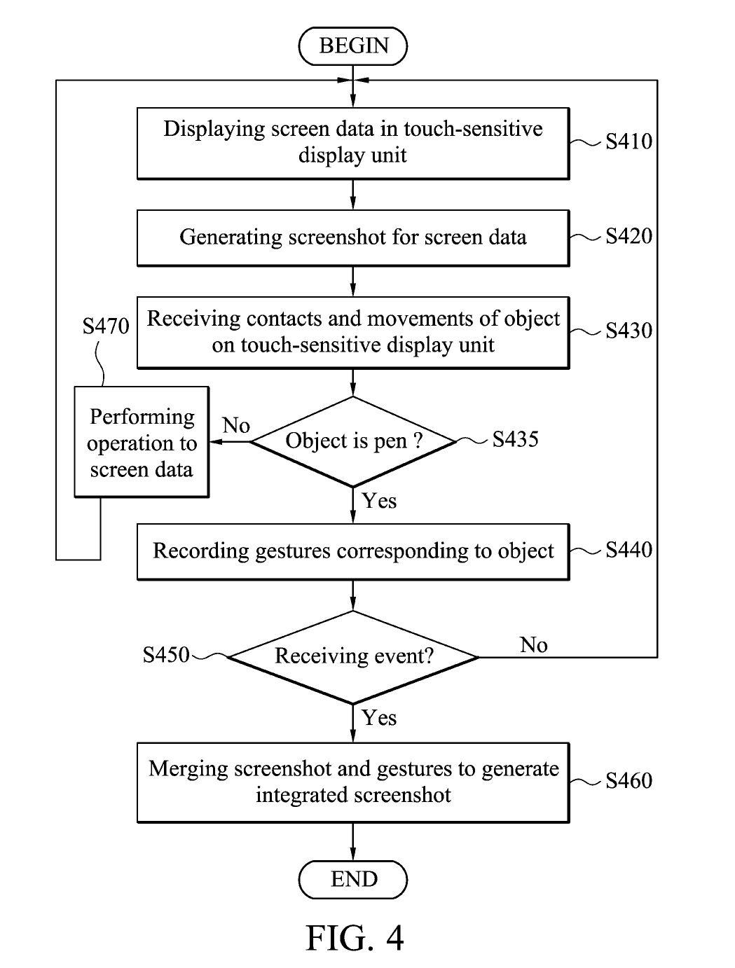

FIG. 4 is a flowchart of another embodiment of a method for screen data management of the invention. The method for screen data management can be used for an electronic device, such as a PDA, a smart phone, a mobile phone, an MID, a laptop computer, a car computer, a digital camera, a multi-media player or a game device.

In step S410, screen data is displayed in the touch-sensitive display unit 120. Similarly, in some embodiments, the screen data can be obtained from the storage unit 110. In some embodiments, the screen data can be downloaded from a web site, and the screen data may be dynamically updated. In step S420, a screenshot for the screen data currently displayed in the touch-sensitive display unit 120 is generated. Similarly, the screen data can be obtained from a memory buffer (not shown) of the touch-sensitive display unit 120, or directly from an application, such as a browser. It is understood that, in some embodiments, the screenshot for the screen data can be generated when an object, such as a pen/stylus or finger touches the touch-sensitive display unit 120. In some embodiments, the screenshot for the screen data can be generated periodically. As described, the screen data may be dynamically updated. In some embodiments, the screenshot for the screen data can be generated when the screen data is updated. It is noted that, the screenshot can be stored in the storage unit 110. In step S430, contacts and movements of the object near or on the touch-sensitive display unit 120 are received/detected. Similarly, in some embodiments, users may use the object to make notes or perform operations to the screen data. In step S435, it is determined whether the object is a pen or not. Similarly, in some embodiments, it is determined whether the object is a pen or not by detecting whether a pen is in proximity to the electronic device or the touch-sensitive display unit. In some embodiments, when a signal transmitted from the pen is detected/received, a pen is determined as in proximity to the electronic device or the touch-sensitive display unit. When the object is a pen (Yes in step S435), in step S440, the gestures corresponding to the object are recorded and stored to the storage unit 110. It is understood that, the contacts and movements of the object on the touch-sensitive display unit 120 can form gestures. In some embodiments, the gestures corresponding to the object can be displayed in the touch-sensitive display unit 120. Similarly, in some embodiments, a multi-layer display technique can be employed in the present application, wherein multiple display layers can be displayed simultaneously in the touch-sensitive display unit 120. When multiple display layers are simultaneously displayed in the touch-sensitive display unit 120, all or a part of a picture displayed in a lower display layer can be covered by another picture displayed in an upper display layer. The upper display layer is visually above the lower display layer. In some embodiments, the gestures corresponding to the object can be displayed in the upper display layer, and the screen data can be displayed in the lower display layer. In step S450, it is determined whether an event is received. It is understood that, in some embodiments, the event may be a save instruction, or a share instruction. If no event is received (No in step S450), the procedure returns to step S410. If an event is received (Yes in step S450), in step S460, the screenshot generated in step S420 and the gestures corresponding to the object on the touch-sensitive display unit are merged to generate an integrated screenshot. In some embodiments, in response to the event, such as a save instruction or a share instruction, the integrated screenshot can be saved to the storage unit or transmitted to a device via a wireless network. When the object is not a pen (No in step S435), in step S470, an operation is performed to the screen data based on the gestures corresponding to the object on the touch-sensitive display unit. For example, when the object is a pen, the gesture corresponding to the object is displayed in the upper display layer, and used to generate a screenshot with the screen data. When the object is not a pen, for example a finger, an operation is performed to the screen data displayed in the lower display layer based on the gesture corresponding to the object. That is, the gesture corresponding to the object is applied to the screen data displayed in the lower display layer when the object is not a pen.

Therefore, the methods and systems for screen data management can automatically generate a screenshot for screen data and gestures of an object, such as notes on the touch-sensitive display unit, thus increasing operational convenience, and reducing power consumption of electronic devices for complicated operations between applications

Methods for screen data management, or certain aspects or portions thereof, may take the form of a program code (i.e., executable instructions) embodied in tangible media, such as floppy diskettes, CD-ROMS, hard drives, or any other machine-readable storage medium, wherein, when the program code is loaded into and executed by a machine, such as a computer, the machine thereby becomes an apparatus for practicing the methods. The methods may also be embodied in the form of a program code transmitted over some transmission medium, such as electrical wiring or cabling, through fiber optics, or via any other form of transmission, wherein, when the program code is received and loaded into and executed by a machine, such as a computer, the machine becomes an apparatus for practicing the disclosed methods. When implemented on a general-purpose processor, the program code combines with the processor to provide a unique apparatus that operates analogously to application specific logic circuits.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalent.

What is claimed is:

1. A computer-implemented method for screen data management, for use in an electronic device, comprising:
generating a screenshot for screen data displayed in a touch-sensitive display unit;
receiving contacts and movements of an object on the touch-sensitive display unit;
determining whether the object is a pen or not;
recording gestures corresponding to the contacts and movements of the object when the object is a pen;
receiving an event; and
in response to the event, merging the screenshot and the gestures corresponding to the contacts and movements of the object to generate an integrated screenshot.

2. The method of claim 1, wherein the screenshot for the screen data displayed in the touch-sensitive display unit is generated periodically.

3. The method of claim 1, wherein the screenshot for the screen data displayed in the touch-sensitive display unit is generated when the object touches the touch-sensitive display unit.

4. The method of claim 1, further comprising displaying the gestures corresponding to the contacts and movements of the object in the touch-sensitive display unit.

5. The method of claim 1, wherein the event comprises a save instruction, or a share instruction.

6. The method of claim 5, further comprising saving the integrated screenshot, or transmitting the integrated screenshot to a device via a wireless network.

7. The method of claim 1, further comprising performing an operation to the screen data displayed in the touch-sensitive display unit based on the gestures corresponding to the contacts and movements of the object when the object is not a pen.

8. The method of claim 1, wherein the step of determining whether the object is a pen or not is performed by detecting whether a pen is in proximity to the electronic device or the touch-sensitive display unit, wherein the pen is in proximity to the electronic device or the touch-sensitive display unit when a signal transmitted from the pen is detected by the electronic device or the touch-sensitive display unit.

9. A system for screen data management for use in an electronic device, comprising:
a storage unit;
a touch-sensitive display unit displaying screen data; and
a processing unit generating a screenshot for the screen data, receiving contacts and movements of an object on the touch-sensitive display unit, determining whether the object is a pen or not, recording gestures corresponding to the contacts and movements of the object to the storage unit when the object is a pen, receiving an event, and in response to the event, merging the screenshot and the gestures corresponding to the contacts and movements of the object to generate an integrated screenshot.

10. The system of claim 9, wherein the processing unit periodically generates the screenshot for the screen data.

11. The system of claim 9, wherein the processing unit generates the screenshot for the screen data when the object touches the touch-sensitive display unit.

12. The system of claim 9, wherein the processing unit further displays the gestures corresponding to the contacts and movements of the object via the touch-sensitive display unit.

13. The system of claim 9, wherein the event comprises a save instruction, or a share instruction.

14. The system of claim 13, wherein the processing unit further saves the integrated screenshot, or transmits the integrated screenshot to a device via a wireless network.

15. The system of claim 9, wherein the processing unit further performs an operation to the screen data displayed in the touch-sensitive display unit based on the gestures corresponding to the contacts and movements of the object when the object is not a pen.

16. The system of claim 9, wherein the processing unit determines whether the object is a pen or not by detecting whether a pen is in proximity to the electronic device or the touch-sensitive display unit, wherein the pen is in proximity to the electronic device or the touch-sensitive display unit when a signal transmitted from the pen is detected by the electronic device or the touch-sensitive display unit.

17. A machine-readable storage medium comprising a computer program, which, when executed, causes a device to perform a method for screen data management, wherein the method comprises:
generating a screenshot for screen data displayed in a touch-sensitive display unit;
receiving contacts and movements of an object on the touch-sensitive display unit;
determining whether the object is a pen or not;
recording gestures corresponding to the contacts and movements of the object;
receiving an event when the object is a pen; and
in response to the event, merging the screenshot and the gestures corresponding to the contacts and movements of the object to generate an integrated screenshot.

18. A computer-implemented method for screen data management, for use in an electronic device, comprising:
displaying screen data in a touch-sensitive display unit;
receiving contacts and movements of an object on the touch-sensitive display unit;
determining whether the object is a pen or not;
displaying gestures corresponding to the contacts and movements of the object in the touch-sensitive display unit when the object is a pen; and
generating a screenshot for the screen data and the gestures corresponding to the object on the touch-sensitive display unit.

19. A machine-readable storage medium comprising a computer program, which, when executed, causes a device to perform a method for screen data management, wherein the method comprises:
displaying screen data in a touch-sensitive display unit;
receiving contacts and movements of an object on the touch-sensitive display unit;
determining whether the object is a pen or not;
displaying gestures corresponding to the contacts and movements of the object in the touch-sensitive display unit when the object is a pen; and
generating a screenshot for the screen data and the gestures corresponding to the object on the touch-sensitive display unit.
